(19) United States
(12) Patent Application Publication
(10) Pub. No.: US 2015/0310842 A1
(43) Pub. Date: Oct. 29, 2015

(54) SYSTEM FOR TRANSPORTING STRINGED INSTRUMENTS AND ASSITING PERFORMERS

(71) Applicant: Gig Armor LLC, Springfield, MO (US)

(72) Inventors: Candy H. Coburn, Springfield, MO (US); Joshua J. Carroll, Branson, MO (US)

(73) Assignee: Gig Armor LLC, Springfield, MO (US)

(21) Appl. No.: 14/263,649

(22) Filed: Apr. 28, 2014

(51) Int. Cl. G10G 7/00; B65D 21/02; A45C 13/26; A45C 13/00; A45C 13/02

(52) U.S. Cl. CPC G10G 7/005; A45C 13/005; A45C 13/02; A45C 13/262; B65D 21/0204; A45C 2013/267

(57) ABSTRACT

A versatile system is provided for transporting stringed instruments between venues, for use during a concert or for convenience during maintenance of an instrument. Storage options within or detachably joined cases are also provided. One or a plurality of instruments may be used in the system.

### BACKGROUND OF INVENTION

1. Field of the Invention

This invention relates to musical instrument cases with special features for a user. More particularly a system including cases that are adaptable for transporting guitars or other stringed instruments and providing features of particular value to a performer is provided.

2. Description of Related Art

Cases for stringed musical instruments are normally designed to protect the instrument from physical damage and to provide a handle for carrying. Guitar cases, in particular, are commonly available is sizes for containing acoustic or electric guitars. They may be made from a variety of materials, from paper to hard plastics or metal. While such devices are adequate for the hobbyist, they fall far sort of satisfying the requirements of professionals, who often change venues for performances and have multiple space and time restrictions. Many musicians can benefit from a system that not only considers the transport of their instrument, but that supports activities necessary during maintenance and use of their instruments.

Multiple instruments are sometimes moved between performance venues. A safe method is needed for stacking cases so that they can be moved by one person. Each musician requires various devices to repair or maintain an instrument. A detachable storage space that can transport tools or devices with the instrument or instruments when needed is desirable. When strings must be replaced on an instrument, a convenient platform for performing the replacement is needed.

U.S. Pat. No. 6,029,804 discloses a dual-chambered carrying case for a musical instrument. The case includes a humidity control system. U.S. Pat. No. 4,223,785 discloses a combination case and stand for a stringed instrument. There is an instrument-display position and an instrument-carrying position. A storage compartment is included in the case. U.S. Pat. No. 4,352,480 discloses a foldable guitar stand for multiple guitars. The stand may be telescoped and folded into a structure sized for a carrying case.

A system for facilitating movement of instruments between performance venues, for allowing easy placement and retrieval of an instrument during a performance and for transporting ancillary supplies and devices used with a string instrument is needed.

### BRIEF DESCRIPTION OF THE SEVERAL VIEWS OF THE DRAWING(S)

FIG. 1 is an isometric view of the base case opened and an instrument in carrying position for a system that may include multiple cases.

FIG. 2 is an isometric view of the base case opened and an instrument placed in concert position for a system that may include multiple cases.

FIG. 3 is a side view of the base case opened and an instrument in repair position for a system that may include multiple cases.

FIG. 5 is a plan view of the base case closed with a detachable supply box and a retractable handle assembly underneath.

FIG. 6 is a side view of the base case closed.

FIG. 7 is an isometric view of the base case closed and a second closed case adapted for transporting with the first case.

FIG. 8 is a side view of the first case closed with wheels and a handle for transport with multiple additional cases.

FIG. 9 is a cross-section view of a detent mechanism used for holding stacked cases together.

### DETAILED DESCRIPTION OF THE INVENTION

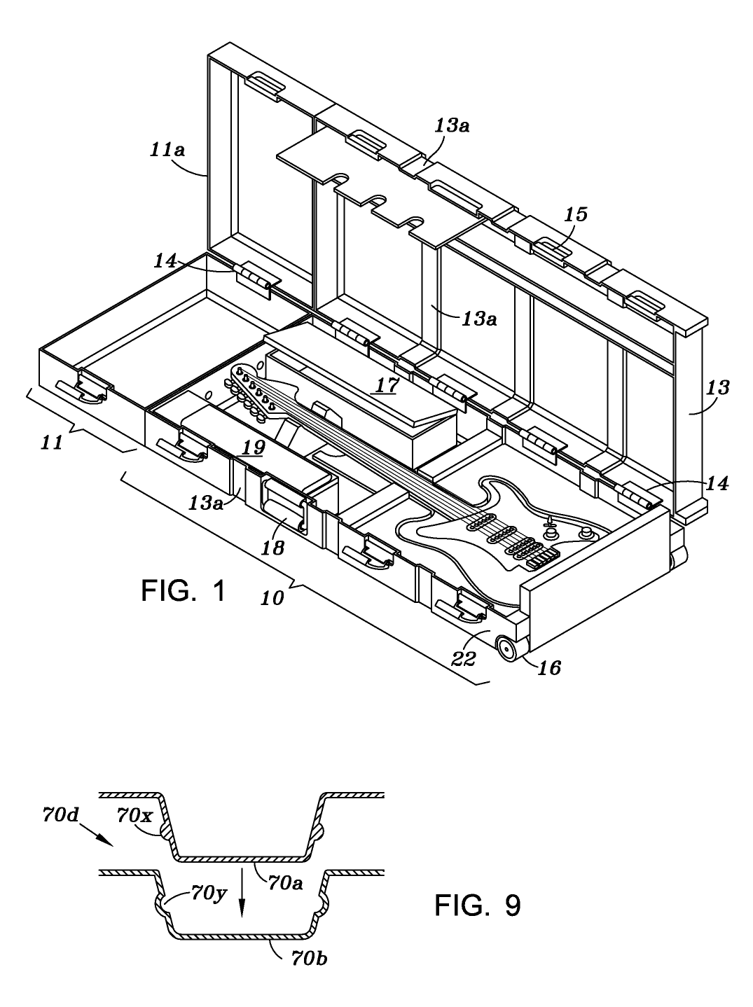

Referring to FIG. 1, base case 10 of a system that may include cases that are adaptable for transporting guitars or other stringed instruments and providing features of particular value to a performer is illustrated in the open position. Base case 10 is adapted to support extra storage box 11, which may be removed when not needed. Base case 10 includes bottom member 12 and top member 13, which are joined by hinges 14. Top member 13 may include tracks 13a to increase structural strength. Fasteners 15 allow securely closing top member 13 and bottom member 12. Wheels 16, preferably inset within bottom member 12 at its distal end, may be used in moving base case 10 and other cases. Internal storage compartments 17 and 19 may be provided. Handle 18 may be used to carry base case 10. Although a guitar is illustrated in the figures, the system may be used with any stringed instrument.

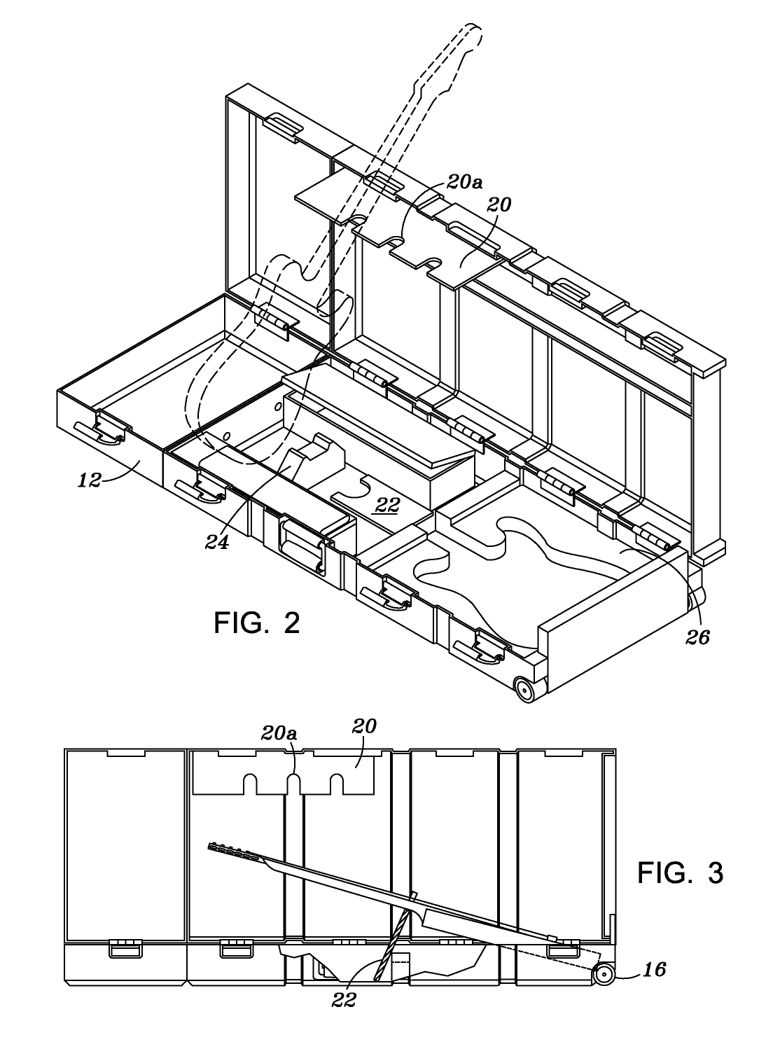

Referring to FIG. 2, rack 20 is illustrated in the concert position. Rack 20 may be foldable toward top member 13 or may be rigid and adapted to fit between storage box 19 and bottom member 12 when case 10 is closed. Instruments may be placed as shown in the figure and removed easily. Cut-outs 20a in rack 20 are provided to support an instrument in a plane that is approximately perpendicular to bottom member 12 by confining the neck of the instrument. Neck support 24 may be used when an instrument is stored. Flip-up support 22 is shown in a stored position and will be described further below. Body support 26 may be formed from foam, memory foam or other materials and covered with a fabric. All surfaces inside base case 10 are selected to avoid damage to delicate surfaces of instruments.

FIG. 3 illustrates rack 20 as foldable and in the stored position and flip-up support 22 in the use position, where it may be used during repair of strings or other parts of an instrument.

FIG. 4 illustrates extra storage box 11 detached from bottom member 12 of base case 10. Fastener 15 and hinges (not shown) may be the same as on base case 10. Box 11 may be joined to bottom member 12 of base case 10 by fasteners 42, which may be selected to operate outside or inside bottom member 12 and storage box 11. Grooves 40a are provided in box 11 and the bottom member of base case 10 to allow handle mechanism 40 to be located approximately flush with box 11 and base case 10.

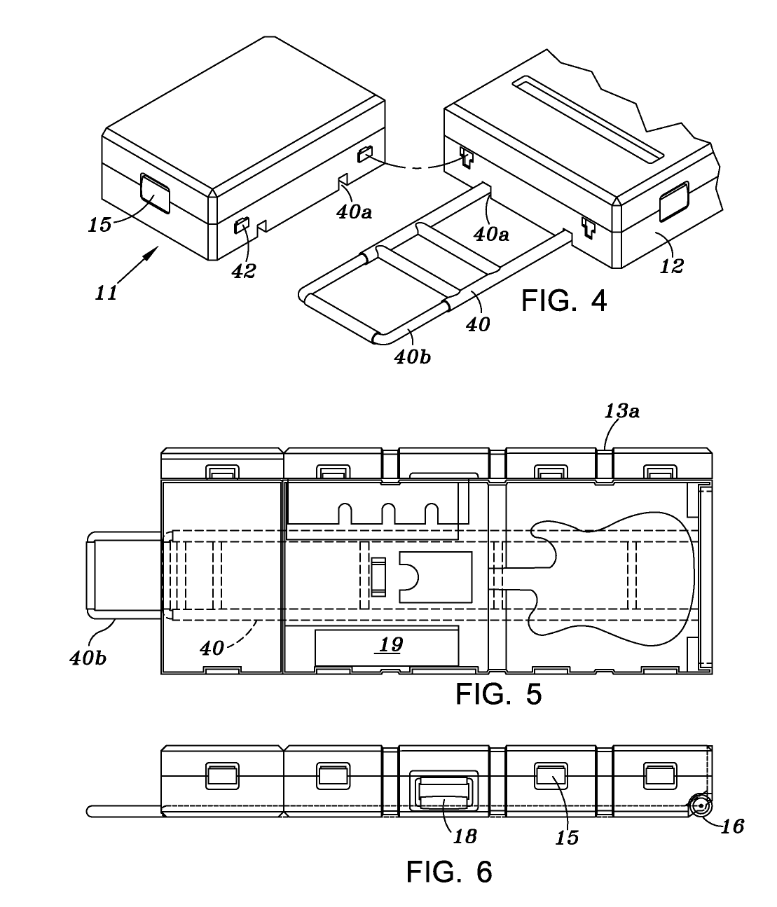

FIG. 5 is a plan view of open base case 10 and handle mechanism 40. Handle mechanism 40 provides a telescopic in-and-out movement of extension 40a at the proximate end of case 10, which can be extended when base case 10 is to be moved on wheels 16 at the distal end of base case 10.

FIG. 6 is a side view of closed base case 10. Wheels 16 are preferably inset into case 10 such that the wheels extend the outside length or height of the case only a small distance or none at all. The outside dimensions of base case 10 and other cases are preferably selected for ease in shipment or storage.

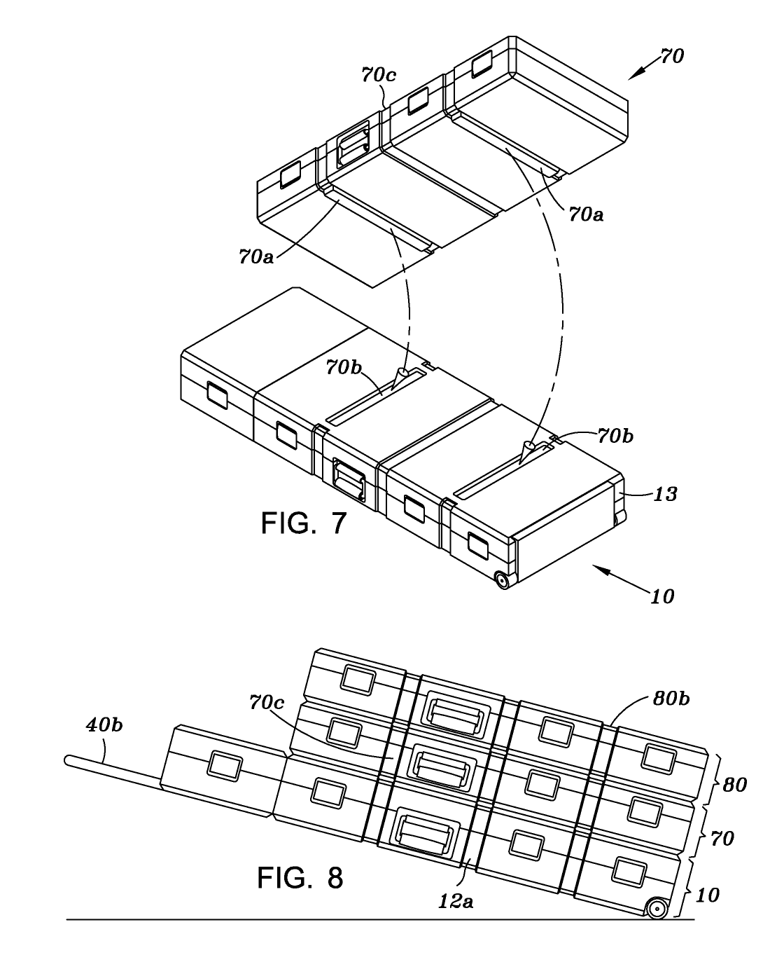

FIG. 7 shows isometric drawings of base case 10 and second case 70. Protruding members 70a on the bottom surface of second case 70 are adapted to be inserted into receptacle 70b in top member 13 of base case 10. These members and receptacles prevent sliding of one case over another and may further include a detent mechanism, as described below. Tracks 70b on case 70 may be used to increase structural strength of the case. Of course, protrusions and receptacles in cases may be interchanged.

FIG. 8 shows a side view of three cases: base case 10, second case 70 and third case 80, stacked and ready for transport using extendable handle 40b. Tracks 80b, 70b, 13a and 12a may be used to increase structural strength of the cases. Straps may be used in the tracks to hold cases together. Straps may be stored conveniently in handle mechanism 40 or other locations in the system of cases and transport devices. Cases 70, 80 or other cases that may be used in the system may include internal storage compartments or flip-up support as shown in base case 10. All cases are preferably formed from polypropylene or a copolymer with propylene, but may be formed from metal or any other material having sufficient structural strength.

FIG. 9 illustrates a simple detent mechanism that may be used to hold stacked cases together. Protrusion 70a may have bump or ridge 70x and be adapted to fit into receptacle 70b, with bump or ridge 70x fitting into pit or groove 70y.

Although the present invention has been described with respect to specific details, it is not intended that such details should be regarded as limitations on the scope of the invention, except to the extent that they are included in the accompanying claims.

I claim:

1. A system for transporting and using stringed musical instruments, comprising:
a base case, the base case comprising a top member and a bottom member joined by hinges and a rack that is positioned when the case is open to support a neck of an instrument; and
an extendable handle disposed on a proximate end and wheels in proximity to a distal end such that the handle and wheels may be used to transport the base case.

2. The system of claim 1 wherein the rack is foldable.

3. The system of claim 1 further comprising a flip-up neck support disposed in the base case.

4. The system of claim 1 further comprising an internal storage compartment in the base case.

5. The system of claim 1 further comprising a detachable extra storage box.

6. The system of claim 1 further comprising a receptacle in an outside surface of the top member of the base case adapted to receive a protruding member.

7. The system of claim 6 further comprising a second case having a protruding member adapted to the receptacle of claim 6.

8. The system of claim 7 further comprising a receptacle in an outside surface of the top member of the second case.

9. The system of claim 8 further comprising a third case having a protrusion adapted to the receptacle of claim 8.

10. The system of claim 7 further comprising a detent mechanism between the base case and the second case.

11. The system of claim 9 further comprising a detent mechanism between the second case and the third case.
